(19) United States
(12) Patent Application Publication
(10) Pub. No.: US 2026/0203729 A1
(43) Pub. Date: Jul. 16, 2026

(54) INTERNET OF THINGS SYSTEMS AND METHODS FOR REGULATION AND CONTROL OF SUPPORT ASSEMBLIES FOR PIPELINES BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Yongzeng LIANG, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 19/562,740

(22) Filed: Mar. 10, 2026

(30) Foreign Application Priority Data
Dec. 16, 2025 (CN) 202511892588.0

(51) Int. Cl. G06Q 10/30

(52) U.S. Cl. CPC G06Q 10/30

(57) ABSTRACT

An IoT system and a method for regulation and control of a support assembly for a pipeline based on smart gas are provided. The system includes a smart gas company sensor network platform, a smart gas equipment object platform, and a smart gas company management platform. The method includes: in response to determining that the current time point is the analysis time point, obtaining sensor data of the gas pipeline network over a preset period; in response to determining that the gas pipeline network is at the target time point within the target deformation cycle, determining at least one of a height variation sequence or a damping variation sequence based on the target time point; generating a height electronic control instruction based on the height variation sequence; and generating a damping electronic control instruction based on the damping variation sequence.

### CROSS-REFERENCE TO RELATED APPLICATIONS

This application claims priority to Chinese Patent Application No. 202511892588.0, filed on December 16, 2025, the entire contents of which are incorporated herein by reference.

### TECHNICAL FIELD

The present disclosure relates to a field of gas pipeline maintenance, and in particular to an Internet of Things (IoT) system and a method for regulation and control of a support assembly for a pipeline based on smart gas.

### BACKGROUND

With the acceleration of urbanization, urban gas pipeline networks have become increasingly complex, and safety and stability of gas pipelines have become crucial for urban energy supply. However, a gas pipeline may be affected by various external forces and internal stresses during operation, leading to gas pipeline deformation and stress concentration, which not only affects normal operation of the gas pipeline but may also trigger safety accidents. To reduce the gas pipeline deformation and stress concentration, a support frame may be used to support the gas pipeline. Although the support frame plays a certain supporting role, the support frame is inadequate for handling complex and variable stress conditions in the gas pipeline.

Therefore, it is desirable to provide an Internet of Things (IoT) system and a method for regulation and control of a support assembly for a pipeline based on smart gas, to more flexibly adjust the support frame, thereby effectively reducing the gas pipeline deformation and stress concentration, and improving safety and stability of the gas pipeline.

### SUMMARY

One or more embodiments of the present disclosure provide a method for regulation and control of a support assembly for a pipeline based on smart gas, the method being implemented by a smart gas company management platform of an Internet of Things (IoT) system for regulation and control of the support assembly for the pipeline based on smart gas. The method comprises: determining whether a current time point is an analysis time point; in response to determining that the current time point is the analysis time point, obtaining sensor data of the gas pipeline network over a preset period from the smart gas equipment object platform; determining a current state of the gas pipeline network based on a current time period corresponding to the current time point, the sensor data, and a gas transmission parameter of the gas pipeline network; determining, based on the current state, whether the gas pipeline network is at a target time point within a target deformation cycle; in response to determining that the gas pipeline network is at the target time point within the target deformation cycle, determining at least one of a height variation sequence or a damping variation sequence based on the target time point; generating a height electronic control instruction based on the height variation sequence, so as to adjust a height of the support assembly in the gas pipeline network based on the height variation sequence before a next analysis time point; and generating a damping electronic control instruction based on the damping variation sequence, so as to adjust a damping of the compensation assembly in the gas pipeline network based on the damping variation sequence before the next analysis time point.

One or more embodiments of the present disclosure provide an Internet of Things (IoT) system for regulation and control of a support assembly for a pipeline based on smart gas. The IoT system comprises a smart gas company sensor network platform, a smart gas equipment object platform, and a smart gas company management platform. The smart gas company management platform is communicatively connected to the smart gas company sensor network platform and the smart gas equipment object platform. The gas equipment object platform includes at least one of the support assembly and a compensation assembly, wherein the support assembly includes at least one electronically-controlled support frame disposed in a gas pipeline network, the electronically-controlled support frame includes a support plate disposed below the gas pipeline, and a left pillar and a right pillar disposed below the support plate. The compensation assembly includes at least one electronically-controlled compensator disposed in the gas pipeline network. The smart gas company management platform is configured to implement the method for regulation and control of a support assembly for a pipeline based on smart gas.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a schematic diagram illustrating an exemplary platform structure of an IoT system for regulation and control of a support assembly for a pipeline based on smart gas according to some embodiments of the present disclosure;

FIG. 2 is a flowchart illustrating an exemplary process of a method for regulation and control of a support assembly for a pipeline based on smart gas according to some embodiments of the present disclosure;

FIG. 3 is a schematic diagram illustrating a determination of a current state of a gas pipeline network according to some embodiments of the present disclosure; and

FIG. 4 is a schematic diagram illustrating an adjustment of an electronically-controlled support frame and/or an electronically-controlled compensator by an IoT system according to some embodiments of the present disclosure.

### DETAILED DESCRIPTION

To more clearly illustrate the technical solutions in the embodiments of the present disclosure, the drawings used in the description of the embodiments will be briefly introduced below. Obviously, drawings described below are only some examples or embodiments of the present disclosure. Those skilled in the art, without further creative efforts, may apply the present disclosure to other similar scenarios according to these drawings. Unless obviously obtained from the context or the context illustrates otherwise, the same numeral in the drawings refers to the same structure or operation.

As shown in the present disclosure and the claims, the singular forms "a", "an", "one", and/or "the" may be intended to include the plural forms as well, unless the context clearly indicates otherwise. Generally, the terms "include" and "comprise" only indicate that the clearly identified steps and elements are included, and these steps and elements do not constitute an exclusive list. The method or device may also include other steps or elements. The term “and/or”, as used herein, is merely a way of describing the associative relationship of an associated object, indicating that three relationships can exist, e.g., A and/or B, which may be represented as: An alone, both A and B, and B alone.

The flowcharts used in the present disclosure illustrate operations that systems implement according to some embodiments of the present disclosure. It should be understood that the operations of the flowcharts may be implemented not in order. Conversely, the operations may be implemented in an inverted order, or simultaneously. Meanwhile, other operations may be added to these processes. One or more operations may be removed from these processes.

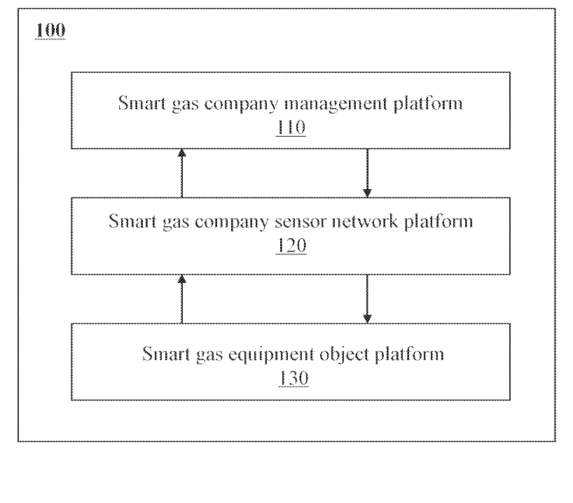

FIG. 1 is a schematic diagram illustrating an exemplary platform structure of an IoT system for regulation and control of a support assembly for a pipeline based on smart gas according to some embodiments of the present disclosure. As shown in FIG. 1, an IoT system 100 for regulation and control of a support assembly for a pipeline based on smart gas (also referred to as an IoT system 100 or an IoT system) may include a smart gas company management platform 110, a smart gas company sensor network platform 120, and a smart gas equipment object platform 130.

The smart gas company management platform 110 (also referred to as a company management platform 110 or a company management platform) refers to a comprehensive management platform for a gas company to process and supervise information.

In some embodiments, the company management platform 110 is configured to execute a method for regulation and control of a support assembly for a pipeline based on smart gas. More descriptions regarding the method may be found in the related descriptions below.

In some embodiments, the company management platform 110 may be configured on a processor and/or a server used by a gas company. The processor and/or the server may process data and/or information obtained from other platforms. Based on the data, the information, and/or processing results, the processor and/or the server may execute program instructions to perform one or more functions described in the present disclosure.

In some embodiments, the company management platform 110 may perform data interaction with the smart gas equipment object platform 130 through the smart gas company sensor network platform 120.

The smart gas company sensor network platform 120 (also referred to as a sensor network platform 120 or a sensor network platform) refers to a functional platform for managing sensor communication of the gas company.

In some embodiments, the sensor network platform 120 may be configured as a communication network or a gateway, etc. The sensor network platform 120 may implement functions of sensing communication of perception information and sensing communication of control information.

In some embodiments, the sensor network platform 120 may interact with the company management platform 110 upstream and interact with the equipment object platform 130 downstream.

The smart gas equipment object platform 130 (also referred to as an equipment object platform 130 or an equipment object platform) refers to a functional platform for the gas company to generate the perception information and execute the control information.

In some embodiments, the equipment object platform 130 may include a support assembly, a compensation assembly 132, a sensor, a pipeline robot, etc.

The support assembly refers to a component configured to provide support for a gas pipeline to reduce deformation of the gas pipeline or reduce stress on the gas pipeline.

In some embodiments, the support assembly includes at least one electronically-controlled support frame disposed in a gas pipeline network. The electronically-controlled support frame includes a support plate disposed below the gas pipeline, and a left pillar and a right pillar below the support plate.

In some embodiments, the electronically-controlled support frame is further provided with a shock absorption mechanism. In some embodiments, the shock absorption mechanism may include a left pillar, a right pillar, a spring, and a lifting block. A bottom of the left pillar and a bottom of the right pillar are each provided with the spring. A top of the spring is slidably connected to the lifting block.

The compensation assembly refers to a component configured to adjust damping of the gas pipeline.

In some embodiments, the compensation assembly includes at least one electronically-controlled compensator connecting adjacent gas pipelines in the gas pipeline network.

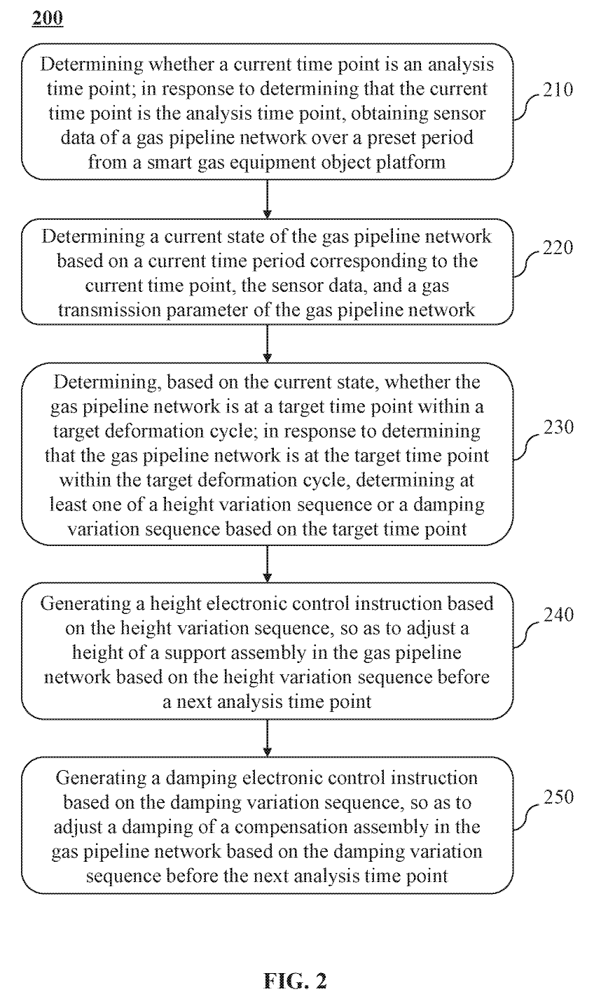

The sensor may be configured to obtain sensor data in the gas pipeline network. More descriptions regarding the sensor data may be found in FIG. 2 and relevant descriptions thereof.

The pipeline robot may receive instructions from the company management platform 110 to enter the gas pipeline network for data collection or other operations.

In some embodiments of the present disclosure, information flow in the IoT system 100 can form a closed loop between various functional platforms. Under the unified management of the smart gas company management platform, the IoT system 100 can operate in a coordinated and regulated manner to achieve smart and information-based regulation and control of the support assembly for the pipeline based on smart gas.

It should be noted that the above descriptions of the IoT 100 and its platforms are only for convenience of description and shall not limit the present disclosure to the scope of the cited embodiments. It may be understood that for those skilled in the art, after understanding the principle of the IoT system, various platforms may be arbitrarily combined, or subsystems may be formed to connect with other platforms without departing from the principle.

FIG. 2 is a flowchart illustrating an exemplary process of a method for regulation and control of a support assembly for a pipeline based on smart gas according to some embodiments of the present disclosure. As shown in FIG. 2, a process 200 includes the following operations. In some embodiments, the process 200 may be executed by the company management platform 110.

In 210, determining whether a current time point is an analysis time point. In response to determining that the current time point is the analysis time point, obtaining sensor data of a gas pipeline network over a preset period from a smart gas equipment object platform.

The analysis time point refers to a time point at which a deformation and/or stress condition of the gas pipeline network needs to be determined.

In some embodiments, the company management platform 110 may determine the current time point through a system clock of the IoT system 100, and determine whether the current time point is the analysis time point in a plurality of ways.

In some embodiments, the company management platform 110 may preset a plurality of time points with equal time intervals as analysis time points. In response to a determination that the current time point matches any one of the analysis time points, the company management platform 110 determines that the current time point is the analysis time point. The time interval may be determined based on prior experience and/or actual requirements. The matching between the current time point and the analysis time point means that a difference between the current time point and the analysis time point is less than a preset time threshold.

The preset period refers to a preset historical time period before the current time point.

In some embodiments, the preset period may be set based on prior experience and/or actual requirements.

The sensor data is data reflecting characteristics of the gas pipeline itself and its surrounding environment. In some embodiments, the sensor data may include at least one of pipeline data or environmental data.

The pipeline data may include, but is not limited to, temperature data of a plurality of collection points inside the pipeline. In some embodiments, the pipeline data may be collected based on temperature sensors. The temperature sensors may be deployed at a plurality of collection points on a pipe wall of the gas pipeline and/or a plurality of collection points in an internal cavity of the gas pipeline. In some embodiments, the collection point is preset.

The environmental data includes at least one of environmental temperature data or environmental humidity data. In some embodiments, the environmental data is obtained based on a temperature sensor and/or a humidity sensor deployed outside the gas pipeline.

In some embodiments, the company management platform 110 controls the temperature sensor and/or the humidity sensor to obtain the sensor data according to a collection parameter in the preset period. The collection parameter includes at least one of a collection frequency or a collection accuracy for data collection by the sensor.

In some embodiments, the company management platform 110 sets the collection parameter based on prior experience and/or actual requirements.

In some embodiments, the collection parameter is further related to an environmental complexity of an environment where the gas pipeline network is located. The environmental complexity reflects a degree of complexity of the environment where the gas pipeline network is located. A higher environmental complexity indicates more frequent and complex changes in the environment where the gas pipeline network is located. In this case, the collection frequency and the collection accuracy for data collection by the sensor are set higher.

In some embodiments, the company management platform 110 determines the environmental complexity based on the environmental data of the environment where the gas pipeline network is located in the preset period. For example, the company management platform 110 determines a range of environmental temperature data and a range of environmental humidity data in the preset period based on the environmental data, and determines an average of the two ranges as the environmental complexity.

In 220, determining a current state of the gas pipeline network based on a current time period corresponding to the current time point, the sensor data, and a gas transmission parameter of the gas pipeline network.

The current time period refers to a time period in which the current time point falls.

In some embodiments, the company management platform 110 divides a plurality of time periods according to a preset standard and numbers the time periods in chronological order, e.g., by week, by month, etc. The preset standard is determined based on actual requirements.

In some embodiments, the company management platform 110 determines the current time period corresponding to the current time point through the system clock provided in the IoT system 100.

The gas transmission parameter refers to a parameter characterizing a gas transmission feature. In some embodiments, the gas transmission parameter includes a gas flow rate, a transmission temperature of gas planned to be transmitted, or other parameters related to gas transmission within a period of time after the current time point, which are determined based on actual requirements.

In some embodiments, the company management platform 110 determines the gas transmission parameter by obtaining a user input or reading a gas transmission plan stored in the IoT system 100.

In some embodiments, the current state of the gas pipeline network includes a deformation cycle in which the gas pipeline network is located, and a time point in the deformation cycle corresponding to the current time point.

The deformation cycle refers to a duration required for a gas pipeline to start from an initial state, undergo multiple deformations, and return to the initial state.

At least one gas pipeline in the gas pipeline network experiences a plurality of deformation cycles due to periodic changes in the environment. For example, periodic changes in light, temperature, and pressure may cause repeated deformations in the gas pipeline.

The time point in the deformation cycle corresponding to the current time point refers to a time point obtained by converting the current time point with reference to the deformation cycle. For example, the time point in the deformation cycle corresponding to a current time point T₀ is an m^{th} second in an n^{th} deformation cycle.

In some embodiments, the company management platform 110 determines the current state of the gas pipeline network in a plurality of ways.

In some embodiments, the company management platform 110 determines the current state of the gas pipeline network by querying a reference state table based on the current time period corresponding to the current time point, the sensor data, and the gas transmission parameter of the gas pipeline network. The reference state table maps reference states to different combinations of current time periods, sensor data, and gas transmission parameters. In some embodiments, the reference state table is preset based on prior experience.

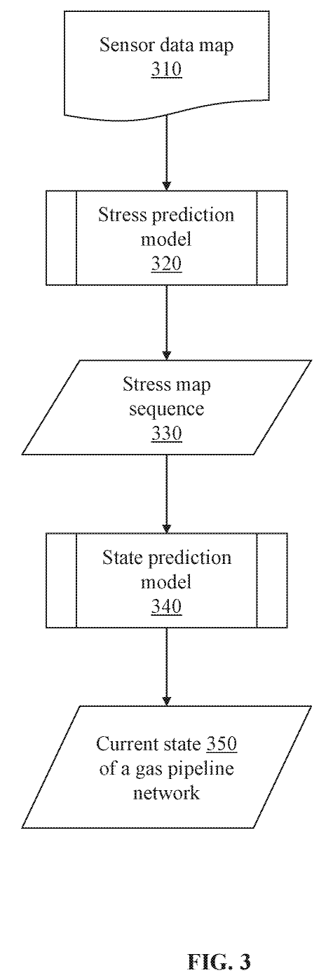

In some embodiments, the company management platform 110 constructs a sensor data map based on the sensor data and the gas pipeline network, processes the sensor data map through a stress prediction model to determine a stress map sequence of the gas pipeline network, and determines the current state of the gas pipeline network based on the stress map sequence. More detailed description may be found in FIG. 3 and relevant descriptions thereof.

In 230, determining, based on the current state, whether the gas pipeline network is at a target time point within a target deformation cycle. In response to determining that the gas pipeline network is at the target time point within the target deformation cycle, determining at least one of a height variation sequence or a damping variation sequence based on the target time point.

The target deformation cycle refers to a deformation cycle in which the support assembly and/or the compensation assembly needs to be regulated and controlled.

The target time point refers to a time point within the target deformation cycle at which regulation and control of the support assembly and/or the compensation assembly are initiated.

In some embodiments, the company management platform 110 presets the target deformation cycle and the target time point based on prior experience.

In some embodiments, the company management platform determines the target deformation cycle and the target time point based on deformation data corresponding to at least one deformation cycle.

The deformation data corresponding to a deformation cycle refers to data reflecting deformation of the gas pipeline network within the deformation cycle. For example, the deformation data includes a time period corresponding to the deformation cycle, a deformation distribution and a stress distribution of the gas pipeline network within the deformation cycle, etc.

In some embodiments, the company management platform 110 determines a deformation cycle with an average deformation value greater than a first deformation threshold as the target deformation cycle, and determines a time point at which the deformation value first becomes greater than a second deformation threshold within the target deformation cycle as the target time point.

In some embodiments, the first deformation threshold and the second deformation threshold are determined based on prior experience, and the first deformation threshold is less than the second deformation threshold.

The height variation sequence refers to sequence data reflecting height adjustment values of the electronically-controlled support frame at at least one time point. The count of elements in the height variation sequence characterizes a frequency of height adjustment for the electronically-controlled support frame, and the value of an element in the height variation sequence represents a height adjustment value (e.g., the magnitude of a height adjustment) for the electronically-controlled support frame.

The damping variation sequence refers to sequence data reflecting damping adjustment values of the electronically-controlled compensator at at least one time point. The count of elements in the damping variation sequence characterizes a frequency of damping adjustment for the electronically-controlled compensator, and the value of an element in the damping variation sequence represents a damping adjustment value (e.g., the magnitude of a damping adjustment) for the electronically-controlled compensator.

In some embodiments, the company management platform 110 adjusts a height of the electronically-controlled support frame and/or a damping of the electronically-controlled compensator at at least one preset time point based on at least one element in the height variation sequence and/or the damping variation sequence.

In some embodiments, the company management platform 110 determines the height variation sequence and the damping variation sequence by querying a reference sequence table based on the target deformation cycle and the target time point. The reference sequence table maps variation sequences to different reference deformation cycles and reference time points, where the variable sequences includes the height variation sequence and the damping variation sequence.

In some embodiments, the company management platform 110 constructs the reference sequence table based on historical data. For example, the company management platform 110 screens historical variable sequences corresponding to historical deformation cycles and historical target time points based on a selection condition, and constructs the reference sequence table based on a historical variable sequences that meets the selection condition. The selection condition may be that after adjusting the support assembly and the compensation assembly based on the historical variable sequence, a stress distribution in the gas pipeline network is most uniform.

In 240, generating a height electronic control instruction based on the height variation sequence, so as to adjust a height of the support assembly in the gas pipeline network based on the height variation sequence before a next analysis time point.

The height electronic control instruction refers to an instruction for instructing the electronically-controlled support frame to perform height adjustment. In some embodiments, the company management platform 110 may determine the height electronic control instruction based on the height variation sequence. For example, the height electronic control instruction may specify adjustments to the electronically controlled support frame within the support assembly of the gas pipeline network, to be executed sequentially according to the adjustment value corresponding to at least one element in the height variation sequence at at least one preset time point.

In some embodiments, the company management platform 110 may send the height electronic control instruction to the equipment object platform 130 to control the electronically-controlled support frame in the support assembly to perform height adjustment according to the adjustment values in the height variation sequence before the next analysis time point.

In some embodiments, in response to a determination that the current time point is the analysis time point, the company management platform 110 may determine a next analysis time point by calculating a sum of the current time point and a preset time interval, starting from a current analysis time point .

In some embodiments, the company management platform 110 may adjust the next analysis time point based on the target time point. Merely by way of example, the company management platform 110 may determine a current deformation cycle based on the target time point, determine an analysis time point that first appears in a next deformation cycle based on the current deformation cycle, and designate the analysis time point as the next analysis time point.

More descriptions regarding the target time point and its determination may be found in operation 230 of FIG. 2 and relevant descriptions thereof.

In 250, generating a damping electronic control instruction based on the damping variation sequence, so as to adjust a damping of the compensation assembly in the gas pipeline network based on the damping variation sequence before the next analysis time point.

The damping electronic control instruction refers to an instruction for instructing the electronically-controlled compensator to perform damping adjustment. In some embodiments, the company management platform 110 may determine the damping electronic control instruction based on the damping variation sequence, and perform damping adjustment on the electronically-controlled compensator in the compensation assembly based on the damping electronic control instruction. The process is similar to the process of determining the height electronic control instruction and adjusting the height of the electronically-controlled support frame, and reference may be found in the relevant descriptions above.

In some embodiments of the present disclosure, by analyzing the deformation cycle of the gas pipeline network and analyzing the deformation condition corresponding to the current time point, the deformation and stress conditions of the pipeline in the gas pipeline network can be updated in real time. Adjustment parameters for the support assembly and the compensation assembly can be determined to reduce stress caused by environmental changes, reduce deformation of the pipeline in the gas pipeline network, and avoid potential pipeline damage caused by long-term deformation. Consequently, enhanced safety is achieved, and the service life of the gas pipeline is better ensured.

It should be noted that the above descriptions of the process 200 are merely for illustration and explanation, and not intended to limit the scope of the present disclosure. For those skilled in the art, multiple variations and modifications to process 200 may be made under the teachings of the present disclosure. However, those variations and modifications do not depart from the scope of the present disclosure.

FIG. 3 is a schematic diagram illustrating a determination of a current state of a gas pipeline network according to some embodiments of the present disclosure. As shown in FIG. 3, the determination of the current state of the gas pipeline network includes following content. In some embodiments, the determination of the current state of the gas pipeline network may be performed by a smart gas company management platform (e.g., the smart gas company management platform 110).

In some embodiments, the smart gas company management platform may determine a stress map sequence 330 of the gas pipeline network through a stress prediction model 320 based on a sensor data map 310; and determine a current state 350 of the gas pipeline network based on the stress map sequence 330.

The sensor data map 310 refers to graph-structured data reflecting a distribution feature of sensor data in the gas pipeline network. The sensor data map includes nodes and edges.

In some embodiments, a node corresponds to a collection point in the gas pipeline network.

In some embodiments, a node feature of a node may include sensor data of the collection point corresponding to the node at a time point.

In some embodiments, an edge refers to a connection relationship between collection points. When two collection points are located on the same gas pipeline or on directly connected gas pipelines, an edge exists between the nodes corresponding to the two collection points, the edge pointing from an upstream point to a downstream point.

In some embodiments, an edge feature of an edge may include a pipeline distance between the nodes connected by the edge.

In some embodiments, the sensor data map may be constructed based on the sensor data. More descriptions regarding the sensor data may be found in FIG. 2 and relevant descriptions thereof.

The stress map sequence 330 refers to sequence data reflecting a stress distribution feature of the gas pipeline network at at least one time point. An element in the stress map sequence corresponds to a stress map of the gas pipeline network at a time point.

In some embodiments, the stress map sequence may include the stress map of the gas pipeline network at at least one time point in a current analysis cycle. The current analysis cycle refers to a time period from the current time point to the next analysis time point.

The stress map refers to graph-structured data reflecting the stress distribution feature in the gas pipeline network. The stress map includes nodes and edges, with a structure similar to the sensor data map, and reference may be made to the relevant descriptions of the sensor data map. The difference is that a node feature in the stress map may include a stress prediction value of the collection point in the gas pipeline network at a time point.

In some embodiments, the company management platform 110 may determine the stress map sequence through the stress prediction model based on a plurality of sensor data maps at different time points.

The stress prediction model 320 refers to a model for predicting the stress map sequence. In some embodiments, the stress prediction model may be a machine learning model, such as a Graph Neural Network (GNN), or other trained machine learning models. In some embodiments, an input of the stress prediction model may be the sensor data map, and an output of the stress prediction model may be the stress map sequence corresponding to the gas pipeline network.

In some embodiments, the stress prediction model may be obtained through training with a large number of first training samples with first labels. In some embodiments, the first training sample may include a plurality of sample sensor data maps. The node features in different sensor data maps correspond to historical sensor data of collection points at different historical time points in the gas pipeline network. The first label may be the stress map sequence corresponding to the first training sample. In some embodiments, the first training sample may be obtained based on historical data. The first label may be constructed based on actual stress values of collection points in the historical gas pipeline network corresponding to the first training sample, measure at a plurality of subsequent time points. Each element in a first label corresponds to a historical actual stress value at a collection point in the gas pipeline network at a subsequent historical time point.

In some embodiments, the company management platform 110 may input a plurality of first training samples with first labels into an initial stress prediction model, construct a loss function based on the first labels and a result of the initial stress prediction model, and iteratively update parameters of the initial stress prediction model through various manners based on the loss function. For example, the update may be performed based on a gradient descent manner, etc. When the loss function of the initial stress prediction model satisfies a preset condition, model training is completed, and a trained stress prediction model is obtained. The preset condition may be that the loss function converges, the count of iterations reaches a threshold, etc.

In some embodiments, the smart gas company management platform may determine the current state of the gas pipeline network in a plurality of ways based on the stress map sequence.

In some embodiments, the company management platform 110 may determine a stress prediction value sequence corresponding to each of a plurality of collection points in the gas pipeline network based on the stress map sequence, and match the stress prediction value sequence corresponding to each collection point with at least one historical stress distribution corresponding to at least one historical deformation cycle. For example, the company management platform may determine at least one historical stress sequence corresponding to each collection point based on the at least one historical stress distribution, determine the historical stress distribution corresponding to the historical stress sequence having a highest matching degree with the stress prediction value sequence as a target stress distribution, and designate the historical deformation cycle corresponding to the target stress distribution as a current deformation cycle of the gas pipeline network. Subsequently, the company management platform determines a time point within the current deformation cycle by matching a current stress distribution of the gas pipeline network with the target stress distribution. For example, the company management platform may determine an element in the target stress distribution that is most similar to the current stress distribution, and determine the time point within the current deformation cycle based on the time point corresponding to the element. If there are a plurality of most similar elements, the company management platform rematches stress distributions of the gas pipeline network at a candidate time point and the current time point with the target stress distribution, determine an element group matching the stress distributions of the gas pipeline network at the candidate time point and the current time point, and determine the time point within the current deformation cycle based on a latest time point in the element group. The candidate time point refers to at least one historical time point closest to the current time point. The larger the count of matching operations performed, the greater the count of candidate time points.

In some embodiments, the company management platform 110 may compare a stress value at a collection point in the target stress distribution with a stress value at the corresponding collection point in the current stress distribution. In response to a determination that a difference between the two is not greater than a preset stress threshold, the two are considered matched. By comparing the stress value at each collection point in the target stress distribution and the stress value at the corresponding collection point in the current stress distribution, the company management platform 110 determines a similarity between the current stress distribution and the target stress distribution based on a ratio of the count of matched collection points to the total count of collection points.

In some embodiments, the company management platform 110 may analyze a historical deformation distribution of the gas pipeline network based on a preset rule, determine at least one historical deformation cycle, and obtain the historical stress distribution of the gas pipeline network within the at least one historical deformation cycle. The preset rule may be determined by a technician based on prior experience. The company management platform 110 may obtain the preset rule uploaded by the technician through a user terminal.

The historical deformation distribution characterizes a deformation distribution of the gas pipeline network in a plurality of historical time periods. The historical time periods may be preset. The deformation distribution refers to deformation points and deformation amounts corresponding to the deformation points in the gas pipeline network at a plurality of time points.

In some embodiments, the company management platform 110 may determine the historical deformation distribution based on historical data collected by a plurality of sensors deployed in the gas pipeline network.

The historical stress distribution refers to a stress distribution of the gas pipeline network in a plurality of historical time periods. The stress distribution refers to a stress of each collection point in the gas pipeline network at the plurality of time points.

In some embodiments, the company management platform 110 may determine the historical stress distribution based on historical data collected by a plurality of sensors deployed at the collection point in the gas pipeline network.

In some embodiments, the company management platform 110 may determine the current state 350 of the gas pipeline network through a state prediction model 340 based on the stress map sequence 330.

The state prediction model 340 refers to a model for predicting the current state of the gas pipeline network. In some embodiments, the state prediction model may be a machine learning model, such as a Graph Neural Network (GNN) model, or other trained machine learning models.

In some embodiments, an input of the state prediction model may include the stress map sequence of the gas pipeline network, and an output of the state prediction model may be the current state of the gas pipeline network.

In some embodiments, the company management platform 110 may determine the state prediction model by iteratively training an initial model based on a plurality of labeled training samples.

In some embodiments, the training sample may include a plurality of sample stress map sequences in historical data of the gas pipeline network. The label may include an actual deformation cycle in which the gas pipeline network is located, and a time point within the deformation cycle.

In some embodiments, the training samples may be obtained based on the historical data, and the labels corresponding to the training samples may be obtained through manual annotation.

The training process of the state prediction model is similar to the training process of the stress prediction model, and reference may be made to the relevant descriptions of the stress prediction model.

In some embodiments, the process of performing iterative training on the initial model includes at least one training cycle. In response to completing a training cycle among the at least one training cycle, the company management platform 110 may adjust a learning rate of the iterative training based on a decay factor. For example, whenever the state prediction model undergoes one training cycle, the smart gas company management platform may multiply the learning rate of the state prediction model by the decay factor. In some embodiments, the decay factor takes a value between 0 and 1 and may be set based on experience.

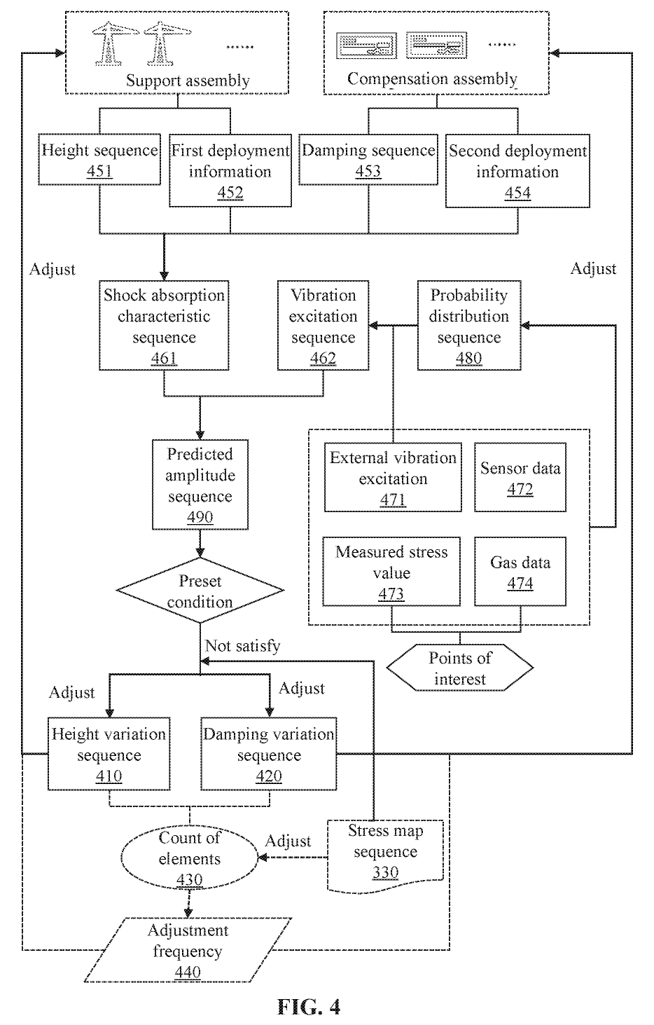

In some embodiments, a training cycle includes a preset count of iterations, the preset count of iterations being related to deployment information of a support assembly within the gas pipeline network. In some embodiments, the greater a standard deviation of initial height values of electronically-controlled support frames in the deployment information of the support assembly, the greater the preset count of iterations may be. More descriptions regarding the deployment information of the support assembly may be found in FIG. 4 and relevant descriptions thereof.

In some embodiments of the present disclosure, when a height distribution of electronically-controlled support frames in the gas pipeline network is relatively non-uniform, by increasing the preset count of iterations, the state prediction model can learn a data feature of a training set. Adjusting the learning rate of the state prediction model according to the height distribution of the electronically-controlled support frames can help the state prediction model converge to an optimal solution better and avoid a failure to converge during training.

In some embodiments of the present disclosure, through the multi-dimensional stress map sequence and the state prediction model, an operating state of the gas pipeline network can be evaluated comprehensively and accurately, potential risks and abnormal situations can be identified, and management personnel can be assisted in taking preventive measures.

In some embodiments of the present disclosure, based on the sensor data collected in real time and the stress prediction model, a future stress change trend can be predicted before the current time point, helping the management personnel fully understand a stress state of the gas pipeline network. Based on the stress map sequence, the current state of the gas pipeline network can be evaluated comprehensively from multiple dimensions, ensuring accuracy and comprehensiveness of an evaluation result.

In some embodiments, the company management platform 110 may control one or more pipeline robots provided with stress sensors to obtain measured stress values at points of interest in the gas pipeline network; and update the stress map sequence based on the measured stress values.

A pipeline robot refers to an automated device used to perform tasks inside a gas pipeline.

A stress sensor refers to a device for measuring stress values at the points of interest in the gas pipeline network, such as an ultrasonic sensor, or the like.

A point of interest refers to a point in the gas pipeline network that requires focused attention. For example, the points of interest may include valves, regulating stations, intersections, joints, etc., in the gas pipeline network. In some embodiments, the points of interest may be a non-empty subset of collection points in the gas pipeline network preset by a technician.

In some embodiments, the company management platform 110 may update the node features of the nodes corresponding to the points of interest in the sensor data map based on the measured stress values at the points of interest. For example, the company management platform 110 adds the measured stress values to the node features to obtain an updated sensor data map, and inputs the updated sensor data map into the stress prediction model to obtain an updated stress map sequence.

In some embodiments of the present disclosure, updating the stress map sequence based on the measured stress values collected by the pipeline robot(s) ensures that the stress map consistently reflects the most current state of the gas pipeline network, thereby better reflecting a stress change trend in the gas pipeline network, which leads to more precise determination of adjustment values for the support assembly and/or the compensation assembly.

In some embodiments, the company management platform 110 may determine a reference deployment density of the support assembly in the gas pipeline network based on the stress map sequence; and adjust a deployment parameter of the support assembly based on the measured stress values at the points of interest and the reference deployment density.

The deployment density refers to the count of support assemblies per unit area in the gas pipeline network. The reference deployment density refers to a recommended value for the deployment density.

In some embodiments, the company management platform 110 may determine the reference deployment density of the support assembly in the gas pipeline network through a cluster analysis based on the stress map sequence.

In some embodiments, the company management platform 110 may construct a map feature vector based on the stress map sequence. The map feature vector includes a map feature corresponding to the stress map of the gas pipeline network at each of at least one time point. The map feature may include a count of edges, a count of nodes, an edge feature sequence, a node feature sequence, etc. Elements in the edge feature sequence and the node feature sequence are arranged in an order predetermined by a user.

In some embodiments, the company management platform 110 may determine at least one reference vector and a corresponding vector label based on historical data. Elements in the reference vector may include a historical map feature corresponding to a historical stress map of the gas pipeline network at each of at least one historical time point in the historical data. The corresponding label may be a historical deployment density of the support assembly in the gas pipeline network at the historical time point. The at least one historical time point refers to ahistorical time point(s) at which no failures occurred in a subsequent time period.

In some embodiments, the historical data may be obtained by the company management platform 110 from a government supervision comprehensive database through a smart gas government safety supervision sensor network platform.

In some embodiments, the company management platform 110 may determine the map feature vector and the at least one reference vector as clustering objects, perform clustering on the clustering objects based on a clustering metric to obtain a plurality of clusters, and designate a cluster containing the map feature vector as a target cluster. The company management platform 110 may determine an average of vector labels corresponding to reference vectors in the target cluster as the reference deployment density of the support assembly in the gas pipeline network. In some embodiments, the clustering metric may be the map feature.

The deployment parameter refers to a parameter used to guide deployment of the support assembly in the gas pipeline network. In some embodiments, the deployment parameter may include at least the deployment density and other parameters related to the deployment of the support assembly.

In some embodiments, the company management platform 110 may adjust the deployment parameter of the support assembly based on the measured stress values at the points of interest and the reference deployment density. For example, the company management platform 110 may divide the gas pipeline network into at least one sub-region based on the points of interest, each sub-region including a preset count of points of interest; determine a sub-region, in which the deployment density of the support assembly is less than the reference deployment density and a range of the measured stress values is greater than a range threshold, as a region to be adjusted; and increase the count of support assemblies in the region to be adjusted, so that the deployment density of the support assembly in the region is not less than the reference deployment density.

In some embodiments, the preset count of points of interest and the range threshold may be set based on prior experience.

In some embodiments of the present disclosure, by analyzing the stress map sequence, the stress distribution in different regions of the gas pipeline network can be comprehensively understood, and a reasonable reference deployment density can be determined by evaluating the demand for the support assembly in each region. By analyzing the measured stress values at the points of interest, the support assemblies in specific regions can be locally optimized, effectively reducing stress concentration in the gas pipeline network and lowering the probability of accidents such as pipeline rupture and leakage.

FIG. 4 is a schematic diagram illustrating an adjustment of an electronically-controlled support frame and/or an electronically-controlled compensator by an IoT system according to some embodiments of the present disclosure. As shown in FIG. 4, the adjustment of the electronically-controlled support frame and/or the electronically-controlled compensator includes following content. In some embodiments, the adjustment of the electronically-controlled support frame and/or the electronically-controlled compensator may be performed by the company management platform 110.

In some embodiments, the company management platform 110 may adjust a count of elements 430 in a height variation sequence 410 and/or a damping variation sequence 420 based on the stress map sequence 330; determine an adjustment frequency 440 based on the count of elements 430; and during a current analysis cycle, control the electronically-controlled support frame to adjust a height of the electronically-controlled support frame based on the adjustment frequency, and/or control the electronically-controlled compensator to adjust a damping of a spring in the electronically-controlled compensator based on the adjustment frequency.

In some embodiments, the company management platform 110 may determine the count of elements in the height variation sequence 410 and/or the damping variation sequence 420 by querying an element count table based on the stress map sequence 330. The element count table may include reference mean sequences of stress fluctuations of collection points in the gas pipeline network, and corresponding reference counts of elements in height variation sequences and/or damping variation sequences, where stress fluctuation values in the reference mean sequences are arranged in a preset order. The element count table may be constructed based on prior experience.

In some embodiments, the company management platform 110 may determine, based on the stress map sequence, a mean of stress fluctuations corresponding to each of a plurality of collection points in the gas pipeline network, organize the means of stress fluctuations corresponding to the plurality of collection points into a fluctuation mean sequence in a preset order (e.g., based on a preset numbering order), and query the element count table based on the fluctuation mean sequence to determine a reference count corresponding to a reference mean sequence with a highest similarity as the count of elements in the height variation sequence and/or the damping variation sequence.

A stress fluctuation refers to a numerical change in stress between the current time point and the previous time point, reflecting the magnitude of stress variation. The company management platform 110 may determine stress fluctuations at two time points for a collection point and calculate the mean of stress fluctuations based on the stress fluctuations at these two time points.

The adjustment frequency includes a height adjustment frequency and a damping adjustment frequency. In some embodiments, the adjustment frequency may be determined based on the count of elements in the height variation sequence and/or the damping variation sequence. For example, if the height variation sequence includes n elements, the company management platform needs to control the electronically-controlled support frame to complete n height adjustments within the current analysis cycle.

In some embodiments, the company management platform 110 may, within the current analysis cycle, control a driving device to drive the electronically-controlled support frame to perform at least one movement according to the values of the elements in the height variation sequence based on the adjustment frequency, so as to adjust a height of the electronically-controlled support frame.

In some embodiments, the company management platform 110 may, within the current analysis cycle, control a current of an electromagnetic device in the electronically-controlled compensator based on the adjustment frequency, so as to adjust a damping of a spring in the electronically-controlled compensator according to the values of the elements in the damping variation sequence, thereby adjusting a stress that the electronically-controlled compensator may compensate.

More descriptions regarding the height adjustment of the electronically-controlled support frame based on the height variation sequence and the damping adjustment based on the damping variation sequence may be found in FIG. 2 and the relevant descriptions thereof.

In some embodiments of the present disclosure, by adjusting the count of elements in the height variation sequence and/or the damping variation sequence based on the stress map sequence, thereby determining the adjustment frequency, and subsequently adjusting the height and the damping based on the adjustment frequency, it is conducive to quickly responding to stress changes, reducing stress concentration, and improving the structural safety of the gas pipeline network.

In some embodiments, the company management platform 110 may further determine a shock absorption characteristic sequence 461 of the gas pipeline network based on a height sequence 451 of at least one electronically-controlled support frame, a damping sequence 453 of at least one electronically-controlled compensator, first deployment information 452 of the support assembly, and second deployment information 454 of the compensation assembly during a current analysis cycle; determine a probability distribution sequence 480 of an external vibration excitation 471 over a future time period based on the external vibration excitation 471 at the current time point, sensor data 472 of the gas pipeline network over the preset period, measured stress values 473 at points of interest in the gas pipeline network, and gas data 474 of the points of interest; determine a predicted amplitude sequence 490 based on the shock absorption characteristic sequence 461 and a vibration excitation sequence 462; in response to the predicted amplitude sequence 490 not satisfying a preset condition, adjust the height variation sequence 410 and the damping variation sequence 420; and adjust a height of the electronically-controlled support frame and a damping of a spring in the electronically-controlled compensator, based on the adjusted height variation sequence and the adjusted damping variation sequence.

The height sequence refers to a sequence composed of height values of the at least one electronically-controlled support frame at at least one time point during the current analysis cycle.

In some embodiments, the company management platform 110 may determine the height sequence based on an initial height of the electronically-controlled support frame and the height variation sequence.

The damping sequence refers to a sequence composed of damping values of the at least one electronically-controlled compensator at at least one time point during the current analysis cycle.

In some embodiments, the smart gas company management platform may determine the damping sequence based on an initial damping of the electronically-controlled compensator and the damping variation sequence.

More descriptions regarding the height variation sequence and the damping variation sequence may be found in FIG. 2 and relevant descriptions thereof.

The first deployment information refers to deployment information of the support assembly. The first deployment information may include position information and an initial height of each electronically-controlled support frame.

The second deployment information refers to deployment information of the compensation assembly. The second deployment information may include position information and an initial damping of each electronically-controlled compensator.

In some embodiments, the first deployment information and the second deployment information may be obtained by the company management platform 110 through the equipment object platform 130. The first deployment information and the second deployment information may also be obtained based on input from a technician.

The shock absorption characteristic sequence refers to data reflecting a magnitude of vibration reduction achieved by the gas pipeline at at least one time point.

In some embodiments, the company management platform 110 may determine the shock absorption characteristic sequence of the gas pipeline network by querying a reference shock absorption characteristic table based on the height sequence of the at least one electronically-controlled support frame, the damping sequence of the at least one electronically-controlled compensator, the first deployment information of the support assembly, and the second deployment information of the compensation assembly during the current analysis cycle. The reference shock absorption characteristic table maps combinations of reference height values of the electronically-controlled support frame, reference damping values of the electronically-controlled compensator, reference deployment information of the support assembly and the compensation assembly, to corresponding reference shock absorption characteristic sequences. In some embodiments, the reference shock absorption characteristic table may be preset based on prior experience.

The probability distribution sequence refers to a probability distribution of external vibration excitation at time points within the current analysis cycle. The probability distribution refers to an occurrence probability of external vibration excitations with different directions and/or intensities. Each element in the probability distribution sequence corresponds to the probability distribution of external vibration excitation at a time point.

The external vibration excitation refers to vibrations caused by changes in the environment surrounding the gas pipeline, including but not limited to vibrations caused by construction activities and subway operations.

In some embodiments, the company management platform 110 may obtain the external vibration excitation through a microwave sensor disposed on an outer wall of the gas pipeline.

In some embodiments, the company management platform 110 may determine the probability distribution sequence of the external vibration excitation over the future time period based on the external vibration excitation at the current time point, the sensor data of the gas pipeline network over the preset period, the measured stress value at the points of interest in the gas pipeline network, and the gas data at the points of interest.

More descriptions regarding the acquisition of the sensor data and the measured stress values may be found in FIG. 2 and the relevant descriptions thereof.

The gas data refers to data reflecting features of gas and its transmission. For example, the gas data may include, but is not limited to, at least one of a gas temperature, a gas humidity, a gas transmission rate, or a gas transmission pressure.

In some embodiments, the company management platform 110 may obtain the gas data through a sensor deployed in the gas pipeline network and/or a pipeline robot equipped with a sensor.

In some embodiments, the company management platform 110 may determine the probability distribution sequence of the external vibration excitation over the future time period in a plurality of ways. For example, the company management platform 110 may construct a target vector based on the external vibration excitation, the sensor data, the measured stress values of the points of interest, and the gas data of the points of interest, calculate similarities between the target vector and feature vectors in a vector database, and designate the label corresponding to a feature vector with a highest similarity as the probability distribution sequence of the external vibration excitation over the future time period.

The vector database may include feature vectors and corresponding labels. The feature vectors may be constructed based on historical external vibration excitations, historical sensor data, historical measured stress values of the points of interest, and historical gas data of the points of interest in historical data.

In some embodiments, the label may be a reference distribution sequence. The reference distribution sequence includes reference values of probability distributions of external vibration excitation at at least one time point.

In some embodiments, the same external vibration excitation may occur a plurality of times at different time points. When the sensor data, the measured stress values, and the gas data are the same, the corresponding feature vector is also the same, that is to say, one feature vector may correspond to multiple instances of external vibration excitation. The company management platform 110 may obtain the probability distribution sequence corresponding to each instance of external vibration excitation associated with a feature vector from the historical data through a preset algorithm, and determine a probability distribution sequence with a highest average probability as the label of the feature vector. The probability distribution sequence with the highest average probability refers to that an average value of the probabilities in the probability distribution sequence is the largest. The preset algorithm may be a time series algorithm, a neural network, an ensemble learning technique, or other techniques capable of determining the external vibration excitation and the probabilities.

In some embodiments, based on the shock absorption characteristic sequence 461 and the vibration excitation sequence 462, the company management platform 110 determines the predicted amplitude sequence 490. In response to the predicted amplitude sequence 490 not satisfying the preset condition, the company management platform 110 may adjust the height variation sequence 410 and the damping variation sequence 420 based on the stress map sequence 330, determine the adjustment frequency based on the count of elements in the adjusted height variation sequence and the adjusted damping variation sequence, and control the electronically-controlled support frame to adjust the height of the electronically-controlled compensator and/or the damping of the spring based on the adjustment frequency during the current analysis cycle. More descriptions of controlling the electronically-controlled support frame to adjust the height of the electronically-controlled compensator and controlling the electronically-controlled compensator to adjust the damping of the spring may be found in FIG. 2 and relevant descriptions thereof.

The vibration excitation sequence refers to a sequence composed of external vibration excitations with the highest occurrence probability. In some embodiments, the company management platform 110 may screen the external vibration excitation 471 based on the probability distribution sequence 480 and construct the vibration excitation sequence 462 based on external vibration excitations with an occurrence probability greater than a probability threshold.

The predicted amplitude sequence refers to a sequence of predicted amplitudes of the gas pipeline. Each element in the predicted amplitude sequence corresponds to the predicted amplitude of the gas pipeline at a time point.

In some embodiments, the predicted amplitude at a time point may be determined as a product of a shock absorption characteristic at the time point and a standard amplitude corresponding to the external vibration excitation. The standard amplitude may be determined based on prior experience. More descriptions regarding the shock absorption characteristic and the external vibration excitation may be found in the relevant descriptions above.

The preset condition may be that an average of predicted amplitudes at each time point in the future time period is not greater than a preset threshold.

In some embodiments, in response to the predicted amplitude sequence not satisfying the preset condition, the company management platform 110 may adjust the height variation sequence and the damping variation sequence based on a preset adjustment rule.

The preset threshold may be preset by a technician based on experience.

In some embodiments, the preset threshold is related to a structural complexity of a current gas pipeline network. The greater the structural complexity of the current gas pipeline network, the smaller the preset threshold.

In some embodiments of the present disclosure, by determining the probability distribution sequence based on the external vibration excitation and the sensor data, and then adjusting the height variation sequence and the damping variation sequence to further adjust the height and the damping, it is conducive to enhancing the real-time responsiveness of the electronically-controlled support frame and the electronically-controlled compensator to different vibration and environmental conditions, improving the effectiveness of responses to the external vibration excitation, reducing stress transmission, and thus better protecting the gas pipeline network.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms "one embodiment", "an embodiment", and/or "some embodiments" mean that a particular feature, structure, or characteristic described in connection with the embodiment is included in at least one embodiment of the present disclosure. Therefore, it is emphasized and should be appreciated that two or more references to "an embodiment" or "one embodiment" or "an alternative embodiment" in various portions of this specification are not necessarily all referring to the same embodiment. Furthermore, the particular features, structures, or characteristics may be combined as suitable in one or more embodiments of the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An Internet of Things (IoT) system for regulation and control of a support assembly for a pipeline based on smart gas, comprising: a smart gas company sensor network platform, a smart gas equipment object platform, and a smart gas company management platform; wherein
the smart gas company management platform is communicatively connected to the smart gas company sensor network platform and the smart gas equipment object platform;
the gas equipment object platform includes at least one of the support assembly and a compensation assembly, wherein
the support assembly includes at least one electronically-controlled support frame disposed in a gas pipeline network, the electronically-controlled support frame includes a support plate disposed below the gas pipeline, and a left pillar and a right pillar disposed below the support plate;
the compensation assembly includes at least one electronically-controlled compensator disposed in the gas pipeline network;
the smart gas company management platform is configured to:
determine whether a current time point is an analysis time point;
in response to determining that the current time point is the analysis time point, obtain sensor data of the gas pipeline network over a preset period from the smart gas equipment object platform;
determine a current state of the gas pipeline network based on a current time period corresponding to the current time point, the sensor data, and a gas transmission parameter of the gas pipeline network;
determine, based on the current state, whether the gas pipeline network is at a target time point within a target deformation cycle;
in response to determining that the gas pipeline network is at the target time point within the target deformation cycle, determine at least one of a height variation sequence or a damping variation sequence based on the target time point;
generate a height electronic control instruction based on the height variation sequence, so as to adjust a height of the support assembly in the gas pipeline network based on the height variation sequence before a next analysis time point; and
generate a damping electronic control instruction based on the damping variation sequence, so as to adjust a damping of the compensation assembly in the gas pipeline network based on the damping variation sequence before the next analysis time point.

2. The system according to claim 1, wherein the smart gas company management platform is further configured to:
adjust the next analysis time point based on the target time point.

3. The system according to claim 1, wherein the smart gas company management platform is further configured to:
determine, based on a sensor data map, a stress map sequence of the gas pipeline network through a stress prediction model, wherein the sensor data map is constructed based on the sensor data, and the stress prediction model is a machine learning model; and
determine the current state of the gas pipeline network based on the stress map sequence;
wherein the stress map sequence includes a stress map of the gas pipeline network at each of at least one time point in a current analysis cycle, the stress map includes a stress prediction value of each of at least one collection point in the gas pipeline network, and the current analysis cycle refers to a time period from the current time point to the next analysis time point.

4. The system according to claim 3, wherein the smart gas company management platform is further configured to:
determine, based on the stress map sequence, the current state of the gas pipeline network through a state prediction model, wherein the state prediction model is a machine learning model.

5. The system according to claim 4, wherein the smart gas company management platform is further configured to:
determine the state prediction model by iteratively training an initial model based on a plurality of labeled training samples, wherein the iterative training includes at least one training cycle; and
in response to completing a training cycle among the at least one training cycle, the smart gas company management platform is further configured to: adjust a learning rate of the iterative training based on a decay factor, wherein the training cycle includes a preset count of iterations, the preset count of iterations being related to deployment information of the support assembly within the gas pipeline network.

6. The system according to claim 3, wherein the smart gas company management platform is further configured to:
adjust a count of elements in at least one of the height variation sequence or the damping variation sequence based on the stress map sequence;
determine an adjustment frequency based on the count of elements; and
during the current analysis cycle, control the at least one electronically-controlled support frame to perform height adjustment based on the adjustment frequency, and/or control the at least one electronically-controlled compensator to perform damping adjustment based on the adjustment frequency.

7. The system according to claim 3, wherein the smart gas company management platform is further configured to:
control one or more pipeline robots provided with stress sensors to obtain measured stress values at points of interest in the gas pipeline network, wherein the points of interest constitute a non-empty subset of the at least one collection point; and
update the stress map sequence based on the measured stress values.

8. The system according to claim 7, wherein the smart gas company management platform is further configured to:
determine a reference deployment density of the support assembly in the gas pipeline network based on the stress map sequence; and
adjust a deployment parameter of the support assembly based on the measured stress values at the points of interest and the reference deployment density.

9. The system according to claim 1, wherein the at least one electronically-controlled support frame is further provided with a shock absorption mechanism; and the smart gas company management platform is further configured to:
determine a shock absorption characteristic sequence of the gas pipeline network based on a height sequence of the at least one electronically-controlled support frame, a damping sequence of the at least one electronically-controlled compensator, first deployment information of the support assembly, and second deployment information of the compensation assembly during a current analysis cycle;
determine a probability distribution sequence of an external vibration excitation over a future time period based on the external vibration excitation at the current time point, the sensor data of the gas pipeline network over the preset period, measured stress values at points of interest in the gas pipeline network, and gas data at the points of interest;
determine a predicted amplitude sequence based on the shock absorption characteristic sequence and the probability distribution sequence;
in response to the predicted amplitude sequence not satisfying a preset condition, adjust the height variation sequence and the damping variation sequence; and
adjust a height of the electronically-controlled support frame and a damping of a spring in the electronically-controlled compensator, based on the adjusted height variation sequence and the adjusted damping variation sequence.

10. A method for regulation and control of a support assembly for a pipeline based on smart gas, the method being implemented by a smart gas company management platform of an Internet of Things (IoT) system for regulation and control of the support assembly for the pipeline based on smart gas,
the IoT system comprising a smart gas company sensor network platform, a smart gas equipment object platform, and the smart gas company management platform, wherein
the smart gas company management platform is communicatively connected to the smart gas company sensor network platform and the smart gas equipment object platform;
the gas equipment object platform includes at least one of the support assembly and a compensation assembly, wherein
the support assembly includes at least one electronically-controlled support frame disposed in a gas pipeline network, the electronically-controlled support frame includes a support plate disposed below the gas pipeline, and a left pillar and a right pillar disposed below the support plate;
the compensation assembly includes at least one electronically-controlled compensator disposed in the gas pipeline network;
the method comprising:
determining whether a current time point is an analysis time point;
in response to determining that the current time point is the analysis time point, obtaining sensor data of the gas pipeline network over a preset period from the smart gas equipment object platform;
determining a current state of the gas pipeline network based on a current time period corresponding to the current time point, the sensor data, and a gas transmission parameter of the gas pipeline network;
determining, based on the current state, whether the gas pipeline network is at a target time point within a target deformation cycle;
in response to determining that the gas pipeline network is at the target time point within the target deformation cycle, determining at least one of a height variation sequence or a damping variation sequence based on the target time point;
generating a height electronic control instruction based on the height variation sequence, so as to adjust a height of the support assembly in the gas pipeline network based on the height variation sequence before a next analysis time point; and
generating a damping electronic control instruction based on the damping variation sequence, so as to adjust a damping of the compensation assembly in the gas pipeline network based on the damping variation sequence before the next analysis time point.

11. The method of claim 10, further comprising:
adjusting the next analysis time point based on the target time point.

12. The method of claim 10, further comprising:
determining, based on a sensor data map, a stress map sequence of the gas pipeline network through a stress prediction model, wherein the sensor data map is constructed based on the sensor data, and the stress prediction model is a machine learning model; and
determining the current state of the gas pipeline network based on the stress map sequence;
wherein the stress map sequence includes a stress map of the gas pipeline network at each of at least one time point in a current analysis cycle, the stress map includes a stress prediction value of each of at least one collection point in the gas pipeline network, and the current analysis cycle refers to a time period from the current time point to the next analysis time point.

13. The method of claim 12, further comprising:
determining, based on the stress map sequence, the current state of the gas pipeline network through a state prediction model, wherein the state prediction model is a machine learning model.

14. The method of claim 13, further comprising:
determining the state prediction model by iteratively training an initial model based on a plurality of labeled training samples, wherein the iterative training includes at least one training cycle; and
in response to completing a training cycle among the at least one training cycle, adjusting a learning rate of the iterative training based on a decay factor, wherein the training cycle includes a preset count of iterations, the preset count of iterations being related to deployment information of the support assembly within the gas pipeline network.

15. The method of claim 12, further comprising:
adjusting a count of elements in at least one of the height variation sequence or the damping variation sequence based on the stress map sequence;
determining an adjustment frequency based on the count of elements; and
during the current analysis cycle, controlling the at least one electronically-controlled support frame to perform height adjustment based on the adjustment frequency, and/or controlling the at least one electronically-controlled compensator to perform damping adjustment based on the adjustment frequency.

16. The method of claim 12, further comprising:
controlling one or more pipeline robots provided with stress sensors to obtain measured stress values at points of interest in the gas pipeline network, wherein the points of interest constitute a non-empty subset of the at least one collection point; and
updating the stress map sequence based on the measured stress values.

17. The method of claim 16, further comprising:
determining a reference deployment density of the support assembly in the gas pipeline network based on the stress map sequence; and
adjusting a deployment parameter of the support assembly based on the measured stress values at the points of interest and the reference deployment density.

18. The method of claim 10, wherein the at least one electronically-controlled support frame is further provided with a shock absorption mechanism; and the method further comprises:
determining a shock absorption characteristic sequence of the gas pipeline network based on a height sequence of the at least one electronically-controlled support frame, a damping sequence of the at least one electronically-controlled compensator, first deployment information of the support assembly, and second deployment information of the compensation assembly during a current analysis cycle;
determining a probability distribution sequence of an external vibration excitation over a future time period based on the external vibration excitation at the current time point, the sensor data of the gas pipeline network over the preset period, measured stress values at points of interest in the gas pipeline network, and gas data at the points of interest;
determining a predicted amplitude sequence based on the shock absorption characteristic sequence and the probability distribution sequence;
in response to the predicted amplitude sequence not satisfying a preset condition, adjusting the height variation sequence and the damping variation sequence; and
adjusting a height of the electronically-controlled support frame and a damping of a spring in the electronically-controlled compensator, based on the adjusted height variation sequence and the adjusted damping variation sequence.

19. A non-transitory computer-readable storage medium, storing computer instructions, wherein when a computer reads the computer instructions in the storage medium, the computer executes a method for regulation and control of a support assembly for a pipeline based on smart gas, the method being implemented by a smart gas company management platform of an Internet of Things (IoT) system for regulation and control of the support assembly for the pipeline based on smart gas,
the method comprising:
determining whether a current time point is an analysis time point;
in response to determining that the current time point is the analysis time point, obtaining sensor data of the gas pipeline network over a preset period from a smart gas equipment object platform;
determining a current state of the gas pipeline network based on a current time period corresponding to the current time point, the sensor data, and a gas transmission parameter of the gas pipeline network;
determining, based on the current state, whether the gas pipeline network is at a target time point within a target deformation cycle;
in response to determining that the gas pipeline network is at the target time point within the target deformation cycle, determining at least one of a height variation sequence or a damping variation sequence based on the target time point;
generating a height electronic control instruction based on the height variation sequence, so as to adjust a height of the support assembly in the gas pipeline network based on the height variation sequence before a next analysis time point; and
generating a damping electronic control instruction based on the damping variation sequence, so as to adjust a damping of the compensation assembly in the gas pipeline network based on the damping variation sequence before the next analysis time point.
